(19) United States
(12) Patent Application Publication
(10) Pub. No.: US 2021/0299922 A1
(43) Pub. Date: Sep. 30, 2021

(54) SHAPING DEVICE AND PRODUCTION METHOD FOR SHAPED OBJECT

(71) Applicant: CASIO COMPUTER CO., LTD., Tokyo (JP)

(72) Inventor: Youichi USHIGOME, Tokyo (JP)

(73) Assignee: CASIO COMPUTER CO., LTD., Tokyo (JP)

(21) Appl. No.: 17/182,349

(22) Filed: Feb. 23, 2021

(30) Foreign Application Priority Data
Mar. 24, 2020 (JP) 2020-052284

(51) Int. Cl. B29C 44/34; B29C 35/08; B29C 44/44; B29C 59/16

(52) U.S. Cl. CPC B29C 44/3415; B29C 35/0805; B29C 44/10; B29C 59/16; B29C 44/44

(57) ABSTRACT

In a shaping device, a conveyor conveys a formable sheet that distends due to being irradiated with electromagnetic waves. An irradiator irradiates the electromagnetic waves on the formable sheet being conveyed by the conveyor. A focus point adjuster adjusts a position of a focus point of the electromagnetic waves irradiated by the irradiator. The focus point adjuster adjusts the position of the focus point in accordance with a degree of definition of an unevenness to be caused to form on the formable sheet due to distension of the formable sheet.

### CROSS-REFERENCE TO RELATED APPLICATION

This application claims the benefit of Japanese Patent Application No. 2020-052284, filed on Mar. 24, 2020, the entire disclosure of which is incorporated by reference herein.

### FIELD

The present disclosure relates generally to a shaping device and a production method for a shaped object.

### BACKGROUND

In the related art, techniques are known for producing a shaped object using a medium that distends as a result of being irradiated with electromagnetic waves. For example, Japanese Unexamined Patent Application Publication No. 2013-178353 discloses an image forming device that forms, as a shaped object, a three-dimensional image by irradiating light on a medium that includes a thermally expansive layer containing a thermally expandable material that expands due to heat. More specifically, the image forming device disclosed in Japanese Unexamined Patent Application No. 2013-178353 forms, on a medium, a developer image using a developer that contains a light absorbing material, and irradiates the medium on which the developer image is formed with light having a wavelength that the developer can absorb.

### SUMMARY

A shaping device according to the present disclosure that achieves the objective described above includes:

a conveyor that conveys a formable sheet that distends due to being irradiated with electromagnetic waves;

an irradiator that irradiates the electromagnetic waves on the formable sheet being conveyed by the conveyor; and

a focus point adjuster that adjusts a position of a focus point of the electromagnetic waves irradiated by the irradiator; wherein

the focus point adjuster adjusts the position of the focus point in accordance with a degree of definition of an unevenness to be caused to form on the formable sheet due to distension of the formable sheet.

### BRIEF DESCRIPTION OF THE DRAWINGS

A more complete understanding of this application can be obtained when the following detailed description is considered in conjunction with the following drawings, in which:

FIG. 1 is a cross-sectional view of a formable sheet according to Embodiment 1 of the present disclosure;

FIG. 2 is a drawing illustrating an example in which a heat conversion layer is formed on the formable sheet depicted in FIG. 1;

FIG. 3 is a drawing illustrating an example in which the formable sheet depicted in FIG. 2 is distended;

FIG. 4 is a perspective view illustrating an example of a shaped object according to Embodiment 1;

FIG. 5 is a schematic drawing illustrating a shaping device according to Embodiment 1;

FIG. 6 is a top view illustrating a tensioner of the shaping device depicted in FIG. 5;

FIG. 7 is a schematic view illustrating an irradiator of the shaping device depicted in FIG. 5;

FIG. 8 is a drawing illustrating an example in which a focus point of the electromagnetic waves is moved in the irradiator depicted in FIG. 7;

FIG. 9 is a block diagram illustrating the configuration of a control unit of the shaping device depicted in FIG. 5;

FIG. 10 is a drawing illustrating an example of degree of definition table stored in the shaping device according to Embodiment 1;

FIG. 11 is a flowchart illustrating the flow of production processing of the shaped object according to Embodiment 1;

FIG. 12 is a block diagram illustrating the configuration of a control unit of a shaping device according to Embodiment 2 of the present disclosure; and

FIG. 13 is a schematic drawing illustrating a shaping device according to a modified example of the present disclosure.

### DETAILED DESCRIPTION

Hereinafter, embodiments of the present disclosure are described while referencing the drawings. Note that, in the drawings, identical or corresponding components are denoted with the same reference numerals.

### Embodiment 1

### Formable Sheet 10

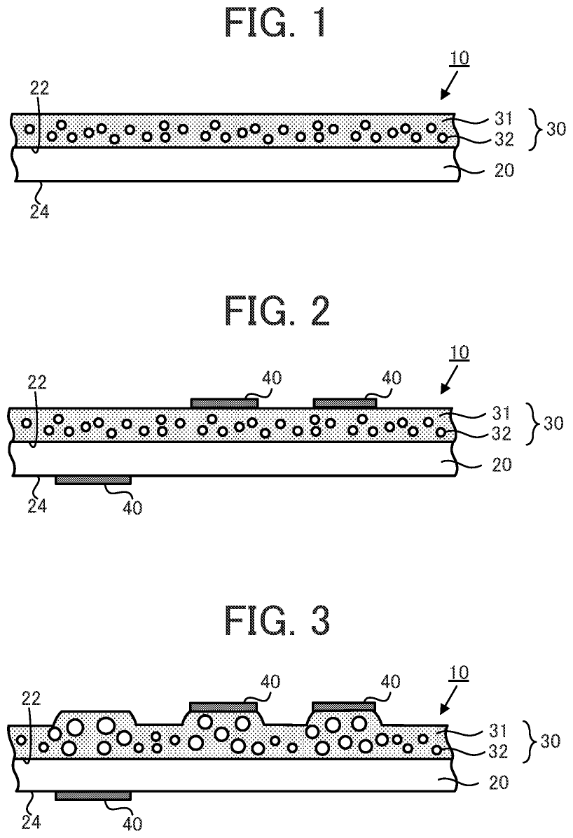

FIG. 1 illustrates a cross-section of the structure of a formable sheet 10 according to Embodiment 1 of the present disclosure. The formable sheet 10 is for producing a shaped object. The formable sheet 10 is a medium in which a pre-selected portion is heated and thereby distended to shape a shaped object. The formable sheet 10 is also called a thermally expandable sheet.

The shaped object is an object having a three-dimensional shape and is shaped in the two-dimensional sheet as a result of a portion of the sheet distending in a direction outward from a front surface of the sheet. The shaped object is also referred to as a three-dimensional object or a three-dimensional image. The shaped object may have a general shape such as a simple shape, a geometrical shape, or a character.

More specifically, the shaped object of Embodiment 1 uses, as a reference, a particular two-dimensional plane within three-dimensional space, and includes unevennesses in a direction perpendicular or in a direction diagonal to that two-dimensional plane. This shaped object is included in a three-dimensional (3-dimensional) images, but to distinguish this shaped object from a three-dimensional image produced using a so-called 3D printing technique, the shaped object is called a 2.5-dimensional (2.5D) image or a pseudo-three-dimensional (pseudo-3D) image. Furthermore, the technique for producing the shaped object is included in three-dimensional image printing techniques, but to distinguish this technique from a so-called 3D printer, the technique is called a 2.5-dimensional printing technique or a pseudo-three-dimensional printing technique. The expression of aesthetics or texture through visual or tactile sensation by shaping (molding) is referred to as “decorating (ornamenting).”

As illustrated in FIG. 1, the formable sheet 10 includes a base 20 and a thermally expansive layer 30. Note that FIG. 1 illustrates a cross-section of the formable sheet 10 in a state prior to the shaped object being produced or, in other words, in a state in which no portions of the formable sheet 10 are distended. In the following, the side of the thermally expansive layer 30 is called the front side of the formable sheet 10, and the side of the base 20 is called the back side of the formable sheet 10.

The base 20 is a sheet-like medium that serves as the foundation of the formable sheet 10. The base 20 is a support body that supports the thermally expansive layer 30, and is responsible for maintaining the strength of the formable sheet 10. Common printer paper, for example, can be used as the base 20. However, the material of the base 20 is not particularly limited and examples thereof include synthetic paper, canvas and similar fabrics, and plastic films such as polypropylene, polyethylene terephthalate (PET), and polybutylene terephthalate (PBT). The base 20 of the formable sheet 10 includes a first main surface 22, and a second main surface 24 on a side opposite the first main surface 22.

The thermally expansive layer 30 is laminated on the first main surface 22 of the base 20, and expands as a result of being heated to a predetermined expansion temperature or higher. The thermally expansive layer 30 includes a binder 31 and a thermally expansive material 32 dispersed in the binder 31. The binder 31 is a thermoplastic resin such as ethylene-vinylacetate polymer or acrylic polymer. Specifically, the thermally expansive material 32 comprises thermally expandable microcapsules (micropowder) having a particle size of about 5 to 50 μm. These microcapsules are formed by encapsulating, in a thermoplastic resin shell, a substance that vaporizes at a low boiling point such as propane or butane. When the thermally expansive material 32 is heated to a temperature of about 80° C. to 120° C., for example, the encapsulated substance vaporizes, and the resulting pressure causes the thermally expandable agent to foam and expand. Thus, the thermally expansive layer 30 expands according to the amount of heat absorbed. The thermally expansive material 32 is also called a foaming agent.

A heat conversion layer 40 that converts electromagnetic waves to heat is formed on portions of the surface of the front side or the back side of the formable sheet 10 to be caused to distend. FIG. 2 illustrates, as an example, a state in which the heat conversion layer 40 is formed on a portion of each of the surface of the front side (specifically, the front surface of the thermally expansive layer 30) and the surface of the back side (specifically, the second main surface 24 of the base 20) of the formable sheet 10. The heat conversion layer 40 is formed by printing on the surface of the front side or the back side of the formable sheet 10 using a printing device such as an ink jet printer or the like.

The heat conversion layer 40 converts electromagnetic waves to heat and radiates the converted heat. As a result, the thermally expansive material 32 in the thermally expansive layer 30 is heated to a predetermined temperature. The temperature to which the thermally expansive material 32 is heated can be controlled by the density of the heat conversion layer 40 formed on the surface of the front side or the back side of the formable sheet 10, and by the amount of energy per unit area and per unit time of the electromagnetic waves irradiated on the heat conversion layer 40. The heat conversion layer 40 converts the electromagnetic waves to heat faster than the other portions of the formable sheet 10. As such, the regions near the heat conversion layer 40 (the thermally expansive layer 30) are selectively heated.

Examples of the material of the heat conversion layer 40 include carbon black, metal hexaboride compounds, and tungsten oxide compounds. Carbon black, for example, absorbs and converts visible light, infrared light, and the like to heat. Metal hexaboride compounds and tungsten oxide compounds absorb and convert near-infrared light to heat. Among the metal hexaboride compounds and the tungsten oxide compounds, lanthanum hexaboride (LaB6) and cesium tungsten oxide are preferable from the perspectives of obtaining high light absorptivity in the near-infrared region and high transmittance in the visible light spectrum.

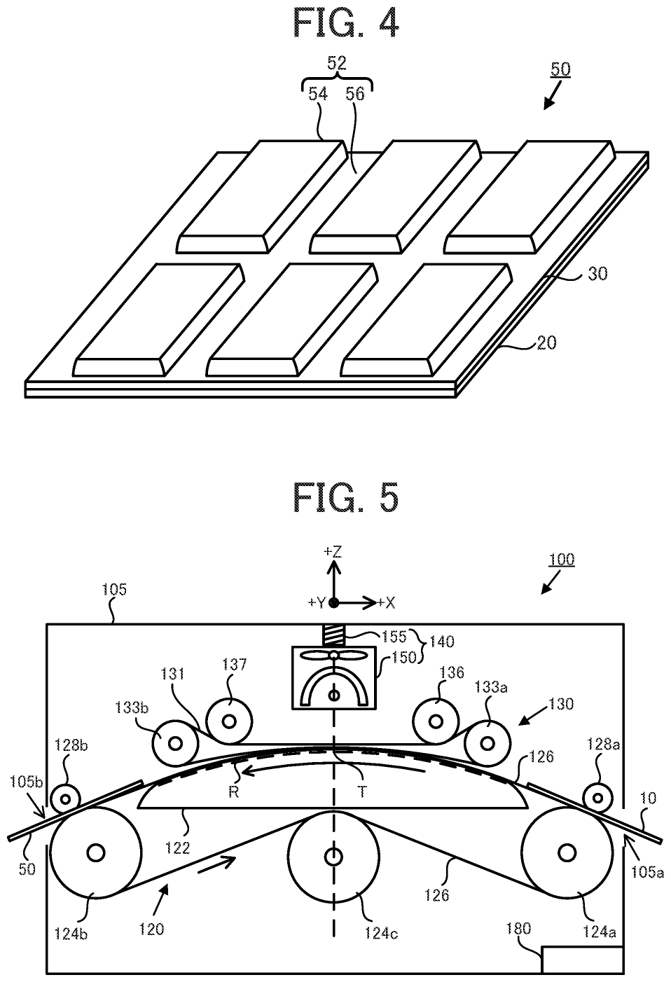

When the thermally expansive layer 30 is heated to the predetermined expansion temperature due to the heat conversion layer 40 converting the electromagnetic waves to heat, the thermally expansive material 32, of the thermally expansive material 32 included in the thermally expansive layer 30, existing at positions corresponding to the regions in which the heat conversion layer 40 is formed expands. As a result, as illustrated in FIG. 3, the portions of the formable sheet 10 where the heat conversion layer 40 is formed rise toward the front side, and bumps are formed. A protruding or uneven shape is formed by the bumps of the thermally expansive layer 30 and, as a result, a shaped object 50 such as illustrated in FIG. 4, for example, is produced.

Shaped Object 50

The shaped object 50 is a sheet-like shaped object, and includes unevennesses 52, specifically a protrusion 54 and a recess 56, on the front surface. The shaped object 50 is used as a decorative sheet, wallpaper, or the like, for example.

As illustrated in FIG. 4, the shaped object 50 includes the base 20, the thermally expansive layer 30 that is laminated on the first main surface 22 of the base 20 and that includes the unevennesses 52 on the side opposite the base 20, and the heat conversion layer 40 that is formed in a pattern corresponding to the unevennesses 52 on the surface of the front side or the back side of the base 20. A variety of shaped objects, including the shaped object 50, can be produced by combining regions in which and distension heights to which the formable sheet 10 is caused to distend.

Shaping Device 100

Next, the shaping device 100 is described. The shaping device 100 produces a shaped object 50 such as that illustrated in FIG. 4, for example, by irradiating the formable sheet 10 with electromagnetic waves to cause the formable sheet 10 to distend. When the formable sheet 10 is to be irradiated with the electromagnetic waves in the shaping device 100, the formable sheet 10 includes the base 20, the thermally expansive layer 30, and the heat conversion layer 40, as illustrated in FIG. 2.

As illustrated in FIG. 5, the shaping device 100 includes a conveyor 120, a tensioner 130, an irradiation unit 140, and a control unit 180. These components are provided within a housing 105. The housing 105 includes a loading port 105a through which the formable sheet 10 is loaded, and a discharge port 105b through which the produced shaped object 50 is discharged.

Note that, to facilitate comprehension, in the shaping device 100 of FIG. 5, the longitudinal right direction (the right direction on paper) is referred to as the “+X direction”, the up direction (the up direction on paper) is referred to as the “+Z direction”, and the direction perpendicular to the +X direction and the +Z direction (the front direction on paper) is referred to as the “+Y direction.”

Conveyor 120

The conveyor 120 conveys the formable sheet 10, loaded through the loading port 105a of the housing 105, along a conveyance route R. The conveyance route R is a route leading from the loading port 105a to the discharge port 105b of the housing 105. The conveyance route R is a convexly curved route, and curves so as to protrude in the +Z direction. A position of the conveyance route R irradiated with the electromagnetic waves by the irradiation unit 140 is a peak T of the conveyance route R.

More specifically, the conveyor 120 includes a guide 122, a driven roller 124a, a driving roller 124b, a tension roller 124c, a conveyor belt 126, a loading roller 128a, and a discharge roller 128b.

The guide 122 is disposed between an outgoing portion and a return portion of the conveyor belt 126. The guide 122 supports the outgoing portion of the conveyor belt 126 from the −Z side while curving along the convexly curved conveyance route R.

The driven roller 124a is disposed on the loading port 105a side (the +X side) of the housing 105, and the conveyor belt 126 is wound on the driven roller 124a. The rotational axis of the driven roller 124a is disposed in a direction (Y direction) orthogonal to the conveyance direction (the −X direction) of the formable sheet 10 and the protruding direction (the +Z direction) of the conveyance route R. The driven roller 124a is axially supported by side plates of the housing 105.

The driving roller 124b is disposed on the discharge port 105b side (the −X side) of the housing 105, and the conveyor belt 126 is wound on the driving roller 124b. The rotational axis of the driving roller 124b is disposed in the Y direction, similar to the rotational axis of the driven roller 124a. The driving roller 124b is axially supported by the side plates of the housing 105. The driving roller 124b rotates counter-clockwise when viewed from the +Y direction due the rotation of a non-illustrated motor, thereby causing the conveyor belt 126 to run.

The tension roller 124c is disposed below (on the −Z side of) the return portion of the conveyor belt 126. The tension roller 124c presses on the return portion of the conveyor belt 126 from the −Z side to apply tension to the conveyor belt 126. The rotational axis of the tension roller 124c is disposed in the Y direction, similar to the rotational axis of the driven roller 124a. The tension roller 124c is axially supported by the side plates of the housing 105.

The conveyor belt 126 is an endless belt that is wound on the driven roller 124a and the driving roller 124b. The outgoing portion of the conveyor belt 126 is supported by the guide 122 and, as such, convexly curves along the convexly curved conveyance route R. The conveyor belt 126 runs due to the rotation of the driving roller 124b. Specifically, the outgoing portion of the conveyor belt 126 runs along the conveyance route R in the −X direction, and the return portion of the conveyor belt 126 runs in the +X direction.

In a case in which the heat conversion layer 40 is formed on the surface of the front side of the formable sheet 10, the formable sheet 10 is placed on the conveyor belt 126 such that the surface of the back side of the formable sheet 10 faces the conveyance surface 126a of the conveyor belt 126, and the surface of the front side of the formable sheet 10 faces upward. Meanwhile, in a case in which the heat conversion layer 40 is formed on the surface of the back side of the formable sheet 10, the formable sheet 10 is placed on the conveyor belt 126 such that the surface of the front side of the formable sheet 10 faces the conveyance surface 126a of the conveyor belt 126, and the surface of the back side of the formable sheet 10 faces upward.

The conveyor belt 126 runs due to the rotation of the driving roller 124b, thereby conveying the formable sheet 10 placed on the conveyor belt 126 in the −X direction along the conveyance route R from the loading port 105a of the housing 105. Moreover, the conveyor belt 126 conveys the shaped object 50, produced by the formable sheet 10 being irradiated with the electromagnetic waves by the irradiator 150, to the discharge port 105b of the housing 105.

Similar to the driven roller 124a, the loading roller 128a is axially supported by the side plates of the housing 105. The formable sheet 10 inserted through the loading port 105a is sandwiched between the loading roller 128a and the conveyor belt 126, and the formable sheet 10 is loaded into the housing 105.

Similar to the driving roller 124b, the discharge roller 128b is axially supported by the side plates of the housing 105. The shaped object 50 produced from the formable sheet 10 is sandwiched between the discharge roller 128b and the conveyor belt 126, and is discharged through the discharge port 105b.

Tensioner 130

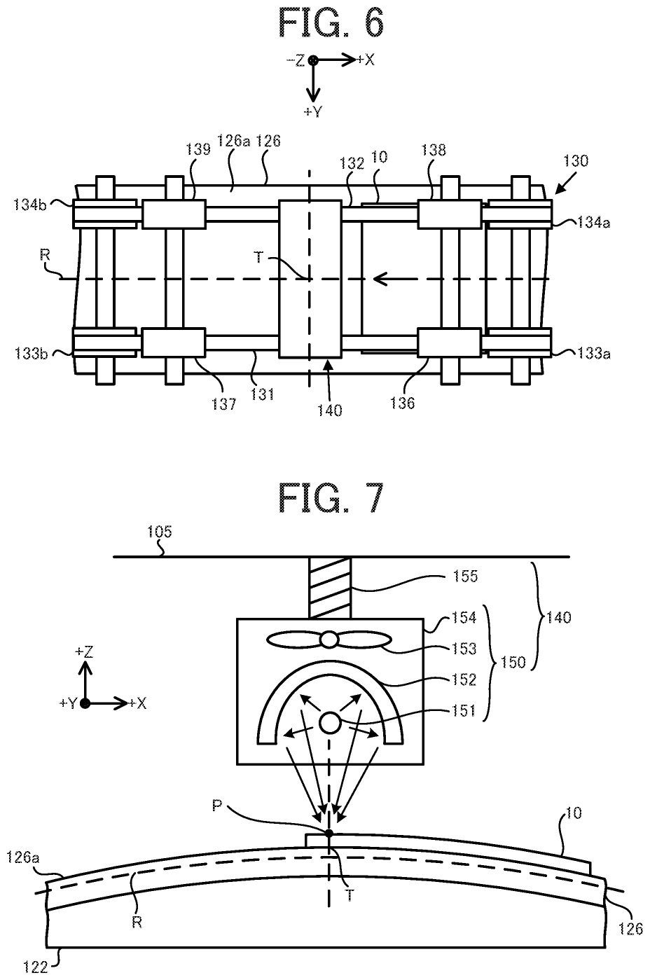

The tensioner 130 applies tension along the convexly curved conveyance route R to the formable sheet 10 being conveyed by the conveyor 120. As illustrated in FIG. 6, the tensioner 130 includes a pair of presser belts 131, 132. Each of the presser belts 131, 132 applies tension along the conveyance route R to the formable sheet 10 by pressing each end of the formable sheet 10 in the width direction of the conveyor belt 126 (the +Y direction end and the −Y direction end) against the conveyor belt 126.

More specifically, the tensioner 130 includes a first pulley 133a and a second pulley 133b on which the presser belt 131 is wound, and a third pulley 134a and a fourth pulley 134b on which the presser belt 132 is wound. Additionally, the tensioner 130 includes two bend pulleys 136, 137 that change the running direction of the presser belt 131, and two bend pulleys 138, 139 that change the running direction of the presser belt 132.

The first pulley 133a and the second pulley 133b are respectively disposed on the +X side and the −X side of the peak T of the conveyor belt 126. A lower end of an outer periphery of the first pulley 133a and a lower end of an outer periphery of the second pulley 133b are positioned more to the −Z side than the peak T of the outgoing portion of the conveyor belt 126. Accordingly, the outgoing portion of the presser belt 131 presses the +Y side end of the formable sheet 10 being conveyed by the conveyor belt 126 against the conveyor belt 126.

The third pulley 134a and the fourth pulley 134b are respectively disposed on the +X side and the −X side of the peak T of the conveyor belt 126. A lower end of an outer periphery of the third pulley 134a and a lower end of an outer periphery of the fourth pulley 134b are positioned more to the −Z side than the peak T of the outgoing portion of the conveyor belt 126. Accordingly, the outgoing portion of the presser belt 132 presses the −Y side end of the formable sheet 10 being conveyed by the conveyor belt 126 against the conveyor belt 126.

Thus, the presser belts 131, 132 respectively press the +Y side end and the −Y side end of the formable sheet 10 against the conveyor belt 126. As such, tension along the conveyance route R is applied to the +Y side end and the −Y side end of the formable sheet 10. As a result, it is possible to suppress warping, bending, and the like of the formable sheet 10 being conveyed by the conveyor 120.

Irradiation Unit 140

The irradiation unit 140 irradiates, with the electromagnetic waves, the formable sheet 10 being conveyed by the conveyor 120. As illustrated in FIG. 5, the irradiation unit 140 is disposed above (on the +Z side of) the peak T of the conveyor belt 126. The irradiation unit 140 irradiates the electromagnetic waves from above toward the surface of the upper side of the formable sheet 10 being conveyed by the conveyor belt 126 while tension is applied by the tensioner 130.

When the formable sheet 10 on which the heat conversion layer 40 is formed is irradiated with the electromagnetic waves from the irradiation unit 140, the heat conversion layer 40 converts the electromagnetic waves to heat and heats the thermally expansive material 32 included in the thermally expansive layer 30 to the predetermined temperature or higher. The heat conversion layer 40 is formed on the surface of the front side or the back side of the formable sheet 10 in a pattern corresponding to the unevennesses 52 of the shaped object 50. As such, the portions of the thermally expansive layer 30 corresponding to the protrusion 54 are heated to the predetermined temperature or higher, and the thermally expansive material 32 expands. As a result, the thermally expansive layer 30 expands and the protrusion 54 (that is, the unevennesses 52) is formed in the thermally expansive layer 30.

More specifically, as illustrated in FIG. 7, the irradiation unit 140 includes an irradiator 150 and a focus point adjuster 155. The irradiator 150 includes a lamp 151, a reflector 152, a fan 153, and a cover 154.

The lamp 151 emits the electromagnetic waves. In one example, the lamp 151 is a halogen lamp, and emits electromagnetic waves in the near-infrared region (750 to 1400 nm wavelength range), the visible light spectrum (380 to 750 nm wavelength range), or the intermediate infrared region (1400 to 4000 nm wavelength range). The lamp 151 is formed in a straight pipe shape in the width direction (Y direction) of the conveyor belt 126 so as to enable the electromagnetic waves to be irradiated evenly in the width direction (Y direction) on the formable sheet 10 that is placed on and is being conveyed by the conveyor belt 126.

The reflector 152 reflects the electromagnetic waves emitted from the lamp 151 toward the formable sheet 10 that is being conveyed by the conveyor belt 126. The reflector 152 is disposed so as to cover the lamp 151 from above. The reflector 152 reflects the electromagnetic waves emitted upward from the lamp 151 downward. The electromagnetic waves emitted from the lamp 151 and reflected by the reflection surface of the reflector 152 advance on the path indicated by the arrows in FIG. 7, and are focused at the focus point P. Thus, the electromagnetic waves emitted from the lamp 151 are reflected by the reflector 152 and, thereby focused and irradiated on the formable sheet 10.

More specifically, the reflector 152 is an ellipsoidal mirror. In other words, a reflection surface of the reflector 152 has the shape of a portion of a spheroid having two focal points. The lamp 151 is disposed at a first focal point of the spheroid. As such, the electromagnetic waves emitted from the lamp 151 and reflected by the reflector 152 are focused at a second focal point of the spheroid. That is, the focus point P of the electromagnetic waves corresponds to the second focal point.

The fan 153 sends air into the cover 154 to cool the lamp 151 and the reflector 152. The cover 154 accommodates the lamp 151, the reflector 152, and the fan 153.

The focus point adjuster 155 adjusts the position of the focus point P of the electromagnetic waves irradiated by the irradiator 150. In this case, the focus point P of the electromagnetic waves is the geographical point where the electromagnetic waves irradiated on the formable sheet 10 by the irradiator 150 are focused. For example, when, as illustrated in FIG. 7, the electromagnetic waves irradiated by the irradiator 150 focus on the formable sheet 10, the focus point P is positioned on the formable sheet 10.

The focus point adjuster 155 includes a movement mechanism that allows the entire irradiator 150, which includes the lamp 151 and the reflector 152, to slide. The focus point adjuster 155 drives the movement mechanism by a non-illustrated motor to move the entire irradiator 150 in a direction perpendicular to the formable sheet 10 being conveyed by the conveyor 120. As a result, the focus point adjuster 155 adjusts the position of the focus point P of the electromagnetic waves.

In this case, the irradiator 150 irradiates the electromagnetic waves when the formable sheet 10 is positioned at the peak T of the conveyance route R, that is, when the surface of the upper side of the formable sheet 10 is facing upward (the +Z direction). As such, specifically, the direction perpendicular to the formable sheet 10 being conveyed by the conveyor 120 corresponds to the vertical direction (the ±Z direction). That is, the focus point adjuster 155 moves the entire irradiator 150 in the vertical direction (the ±Z direction).

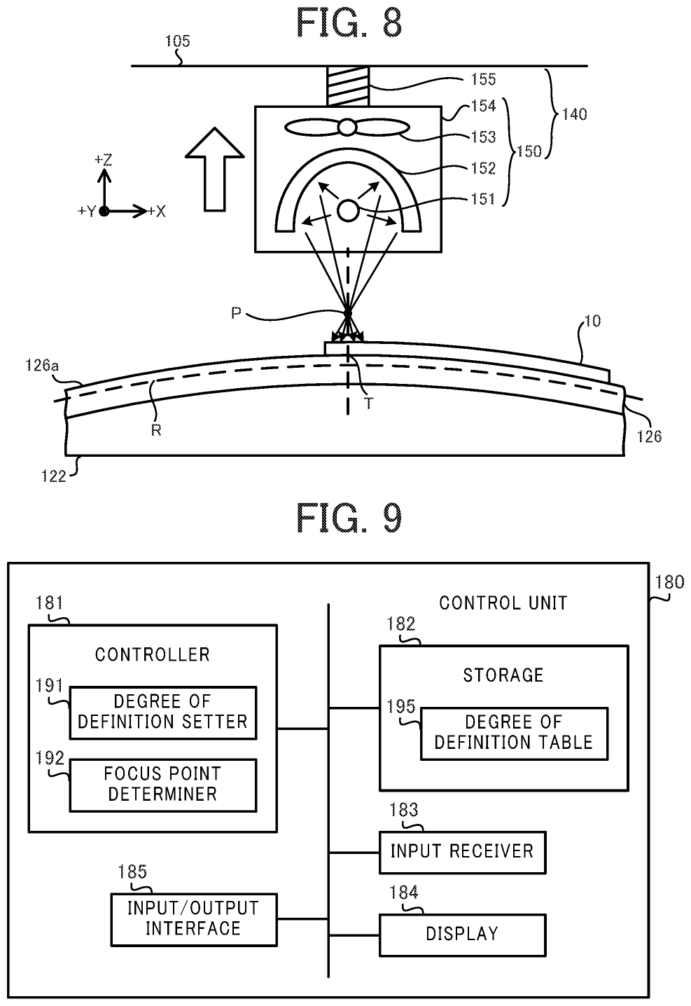

When the irradiator 150 is moved in the vertical direction, the two focal points of the reflector 152 also move in the vertical direction. As a result, the focus point P of the electromagnetic waves irradiated by the irradiator 150 moves in the vertical direction. For example, when the focus point adjuster 155 drives the movement mechanism to move the focus point P upward (in the +Z direction) from the state illustrated in FIG. 7, the focus point P deviates from the position on the formable sheet 10 as illustrated in FIG. 8. Thus, the focus point adjuster 155 adjusts the position of the focus point P by moving the irradiator 150 in the vertical direction.

Control Unit 180

Returning to FIG. 5, the control unit 180 controls the operations of the various components of the shaping device 100, including the conveyor 120 and the irradiator 150 described above. As illustrated in FIG. 9, the control unit 180 includes a controller 181, a storage 182, an input receiver 183, a display 184, and an input/output interface 185. Each of these constituents is connected to a bus for transmitting signals.

The controller 181 includes a central processing unit (CPU), read only memory (ROM), and random access memory (RAM). In one example, the CPU is a microprocessor or the like and is a central processing unit that executes a variety of processing and computations. In the controller 181, the CPU reads a control program stored in the ROM and controls the operations of the entire shaping device 100 while using the RAM as working memory.

The storage 182 is nonvolatile memory such as flash memory or a hard disk. Data and programs to be executed by the controller 181 are stored in the storage 182. In particular, the storage 182 stores a degree of definition table 195 that defines the degree of definition of the unevennesses 52 in accordance with the shaped object 50 to be produced.

The input receiver 183 includes an input device such as various types of buttons, a touch pad, a touch panel, or the like, and receives operation inputs (user operations) from a user. For example, the user can set the type of shaped object 50 to be produced, the type of formable sheet 10 to be used to produce that shaped object 50, or the like by operating the input receiver 183.

The display 184 includes a display device such as a liquid crystal display, an organic electro luminescence (EL) display, or the like, and displays various images on the basis of commands from the controller 181. For example, the display 184 displays a setting screen for producing the shaped object 50 on the formable sheet 10.

The input/output interface 185 is an interface for inputting and outputting signals sent and received to and from the controller 181 and the various components of the shaping device 100.

As illustrated in FIG. 9, the controller 181 functionally includes a degree of definition setter 191, a focus point determiner 192, and a conveyance speed determiner 193. In the control unit 181, the CPU performs control and reads the program stored in the ROM out to the RAM and execute that program, thereby functioning as the various components described above.

The degree of definition setter 191 sets the degree of definition of the unevennesses 52 to be caused to form on the formable sheet 10 due to distension of the formable sheet 10. In this case, the degree of definition is a value representing the fineness of the unevennesses 52 to be formed on the formable sheet 10. As the degree of definition increases, bumps with sharper edges can be formed when bumps are to be formed due to distension of the formable sheet 10. As a result, a shaped object 50 having finer unevennesses 52 can be produced. In contrast, as the degree of definition decreases, only bumps with smoother edges can be formed. As a result, the unevennesses 52 of the produced shaped object 50 are coarser.

The degree of definition setter 191 sets the degree of definition in accordance with the shaped object 50 to be produced from the formable sheet 10. Specifically, the degree of definition setter 191 references a degree of definition table 195 stored in the storage 182. The degree of definition table 195 is a table that defines the degree of definition of the unevennesses 52 to be formed on the formable sheet 10.

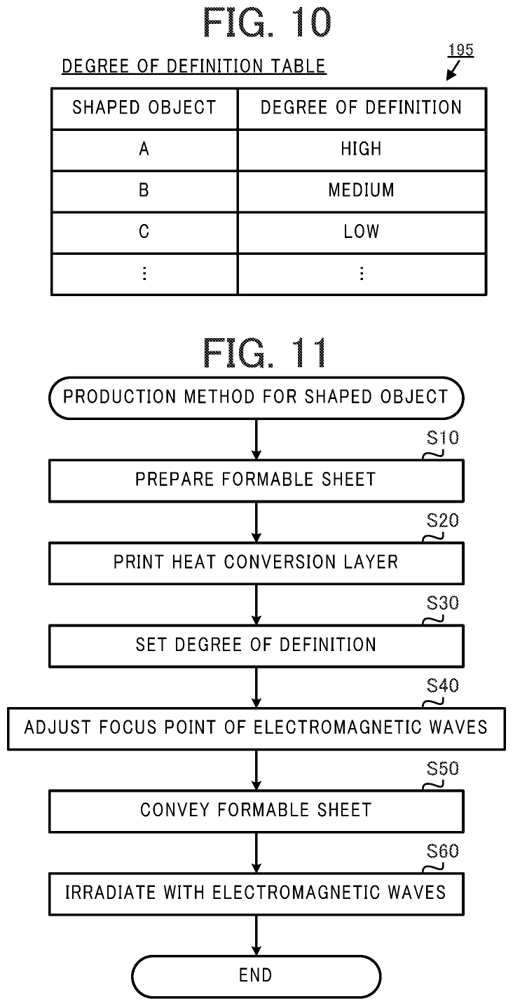

Specifically, as illustrated in FIG. 10, the degree of definition table 195 associates the shaped object 50 to be produced and the degree of definition of the unevennesses 52 when producing that shaped object 50, and stored that associated information. As an example, in FIG. 10, the degree of definition includes three levels, namely “high”, “medium”, and “low”, and these levels are associated with various shaped objects 50. The degree of definition setter 191 references such a degree of definition table 195 to set the degree of definition.

Returning to FIG. 5, the focus point determiner 192 determines, in accordance with the degree of definition set by the degree of definition setter 191, the position of the focus point P of the electromagnetic waves to be irradiated by the irradiator 150. The lower the degree of definition set by the degree of definition setter 191, the more the focus point determiner 192 moves the irradiator 150 in a direction away from the position on the formable sheet 10. As a result, the position of the focus point P of the electromagnetic waves is moved significantly from on the formable sheet 10 being conveyed by the conveyor 120.

Specifically, in a case in which the degree of definition setter 191 sets the degree of definition to the maximum degree of definition, the focus point determiner 192 determines the focus point P at the position on the formable sheet 10 as illustrated in FIG. 7. In this case, the electromagnetic waves irradiated on the formable sheet 10 are irradiated so as to be concentrated in only a narrow range on the formable sheet 10. As such, the unevennesses 52 formed due to the formable sheet 10 distending have relatively high definition.

In contrast, in a case in which the degree of definition setter 191 sets the degree of definition to the lowest degree of definition, the focus point determiner 192 determines the focus point P at a position separated in the up direction (the +Z direction) from the formable sheet 10 as illustrated in FIG. 8. In this case, the electromagnetic waves irradiated on the formable sheet 10 are broadly irradiated across a wide range on the formable sheet 10. As such, the unevennesses 52 formed due to the formable sheet 10 distending have relatively not-high definition.

When the focus point determiner 192 determines the position of the focus point P, the focus point determiner 192 notifies the focus point adjuster 155 of the determined position of the focus point P via the input/output interface 185. When the focus point adjuster 155 receives the notification of the position of the focus point P from the focus point determiner 192, the focus point adjuster 155 moves the irradiator 150 in the vertical direction (the Z direction), thereby moving the focus point P of the electromagnetic waves to the position determined by the focus point determiner 192. Thus, the focus point adjuster 155 adjusts the position of the focus point P in accordance with the degree of definition of the unevennesses 52 to be caused to form on the formable sheet 10 due to distension of the formable sheet 10.

Thus, the focus point determiner 192 changes the focus point P of the electromagnetic waves in the vertical direction in accordance with the degree of definition set by the degree of definition setter 191. As a result, the degree of definition of the unevennesses 52 to be formed on the formable sheet 10 can be switched in accordance with the shaped object 50 to be produced.

Production Processing of Shaped Object

Next, the flow of production processing of the shaped object 50 is described while referencing the flowchart illustrated in FIG. 11.

When the production processing of the shaped object 50 illustrated in FIG. 11 starts, firstly, the formable sheet 10 is prepared (step S10). Specifically, a coating liquid obtained by mixing the binder 31 and the thermally expansive material 32 is screen printed on the first main surface 22 of the base 20, and the printed coating liquid is dried. As a result, a formable sheet 10 such as illustrated in FIG. 1 in which the thermally expansive layer 30 is laminated on the first main surface 22 of the base 20 is produced.

After the formable sheet 10 is prepared, the heat conversion layer 40 is printed on the prepared formable sheet 10 (step S20). Specifically, a printing device prints ink containing the heat conversion material in a gray-scale pattern corresponding to the unevennesses 52 on the surface of the front side (that is, the front surface of the thermally expansive layer 30) of the formable sheet 10 or the surface of the back side (that is, the second main surface 24 of the base 20) of the formable sheet 10. In one example, the printing device is an ink jet printer.

When the heat conversion layer 40 is printed on the formable sheet 10, the control unit 180 sets the degree of definition of the unevennesses 52 to be formed on the formable sheet 10 (step S30). Specifically, the degree of definition setter 191 receives, from the user via the input receiver 183, an input of the shaped object 50 to be produced. Then, the degree of definition setter 191 references the degree of definition table 195 to set the degree of definition that corresponds to the received input of the shaped object 50 to be produced.

When the degree of definition is set, the position of the focus point P of the electromagnetic waves to be irradiated by the irradiator 150 is adjusted (step S40). Specifically, the focus point determiner 192 determines the position of the focus point P of the electromagnetic waves in accordance with the degree of definition set in step S30, such that the lower the degree of definition is, the farther the focus point P is from the position on the formable sheet 10. Then, the focus point adjuster 155 moves the irradiator 150 in the vertical direction (the Z direction), thereby moving the focus point P of the electromagnetic waves to be irradiated by the irradiator 150 to the position determined by the focus point determiner 192.

When the position of the focus point P of the electromagnetic waves is adjusted, the conveyor 120 conveys the formable sheet 10 (step S50). Specifically, the user inserts the formable sheet 10, on which the heat conversion layer 40 is printed, through the loading port 105a of the shaping device 100. In a case in which the heat conversion layer 40 is printed on the surface of the front side of the formable sheet 10, the user inserts the formable sheet 10 through the loading port 105a with the surface of the front side of the formable sheet 10 facing upward. In a case in which the heat conversion layer 40 is printed on the surface of the back side of the formable sheet 10, the user inserts the formable sheet 10 through the loading port 105a with the surface of the back side of the formable sheet 10 facing upward. The conveyor 120 operates on the basis of the control of the control unit 180 and causes the driving roller 124b to rotate, thereby causing the conveyor belt 126 to run. As a result, the conveyor 120 conveys the inserted formable sheet 10 along the conveyance route R.

When the formable sheet 10 is conveyed, the formable sheet 10 is irradiated with the electromagnetic waves by the irradiator 150 (step S60). Specifically, the irradiator 150 operates on the basis of the control of control unit 180, and emits the electromagnetic waves toward the formable sheet 10 that is being conveyed by the conveyor 120. As a result, the heat conversion layer 40 printed on the formable sheet 10 converts the electromagnetic waves to heat, thereby generating heat. When the thermally expansive material 32 included in the thermally expansive layer 30 is heated by the heat emitted from the heat conversion layer 40 to the temperature at which expansion starts, the thermally expansive layer 30 starts to expand and the unevennesses 52 are formed. As a result, the shaped object 50 is produced.

Thus, the shaped object 50 is produced from the formable sheet 10. The produced shaped object 50 is conveyed along the conveyance route R by the conveyor 120, and discharged through the discharge port 105b of the shaping device 100. At this time, as desired, a color image may be printed by a printing device on the surface of the front side or the surface of the back side of the formable sheet 10 in order to enhance the decorativeness of the produced shaped object 50.

Note that, in cases in which the heat conversion layer 40 is printed on both the surface of the front side and the surface of the back side of the formable sheet 10 to cause the formable sheet 10 to distend, the heat conversion layer 40 is printed on each of the surface of the front side and the surface of the back side, and the processing of steps S20 to S60 is repeated. In this case, for example, the degree of definition setter 191 may set different degrees of definition for when the heat conversion layer 40 is printed on the surface of the front side and when the heat conversion layer 40 is printed on the surface of the back side, and the focus point adjuster 155 may move the focus point P of the electromagnetic waves to different positions.

As described above, the shaping device 100 according to Embodiment 1 includes the conveyor 120 that conveys the formable sheet 10, which distends due to being irradiated with electromagnetic waves, along the conveyance route R, the irradiator 150 that irradiates the electromagnetic waves on the formable sheet 10 that is being conveyed by the conveyor 120, and the focus point adjuster 155 that adjusts the position of the focus point P of the electromagnetic waves to be irradiated by the irradiator 150. Moreover, the focus point adjuster 155 adjusts the position of the focus point P in accordance with the degree of definition of the unevennesses 52 to be caused to form on the formable sheet 10 due to distension of the formable sheet 10. It is only possible to form unevennesses 52 having a specific degree of definition when the focus point P of the electromagnetic waves is fixed. However, the shaping device 100 according to Embodiment 1 can adjust the position of the focus point P of the electromagnetic waves in accordance with the degree of definition of the unevennesses 52 to be caused to form on the formable sheet 10. As such, the shaping device 100 according to Embodiment 1 can form, on the formable sheet 10, unevennesses 52 of various degrees of definition in accordance with the preferences of the user.

For example, depending on the shaped object 50 to be produced, there are cases in which the unevennesses 52 are to be formed in a sharp manner (high definition) and cases in which the unevennesses 52 are to be formed in a smooth manner (not-high definition). In contrast, the shaping device 100 according to Embodiment 1 can create high-definition unevennesses 52 and not-high-definition unevennesses 52 by switching in accordance with the shaped object 50 to be produced. Therefore, it is possible to expand the range of shaped objects 50 that can be produced.

### Embodiment 2

Next, Embodiment 2 of the present disclosure is described. In Embodiment 2, as appropriate, descriptions of configurations and functions that are the same as described in Embodiment 1 are forgone.

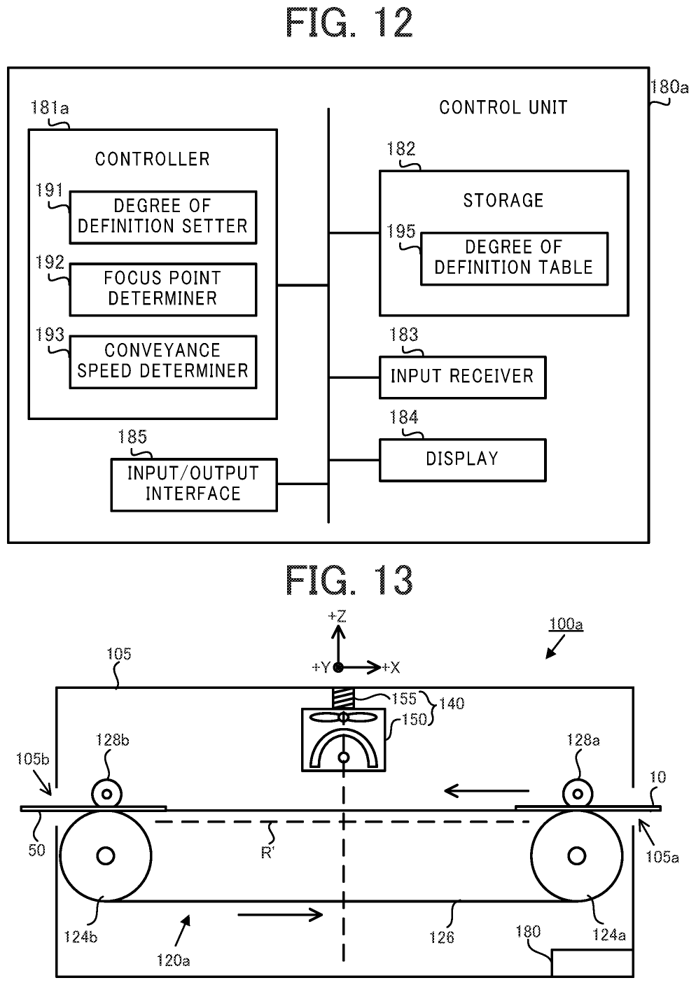

FIG. 12 illustrates the configuration of a control unit 180a of a shaping device 100 according to Embodiment 2. A controller 181a of the control unit 180a functionally includes a degree of definition setter 191, a focus point determiner 192, and a conveyance speed determiner 193. In the controller 181a, the CPU performs control and reads the program stored in the ROM out to the RAM and executes that program, thereby functioning as the various components described above. The degree of definition setter 191, the focus point determiner 192, and components of the control unit 180a other than the controller 181a are the same as in Embodiment 1 and, as such, description thereof is omitted.

The conveyance speed determiner 193 determines, in accordance with the degree of definition set by the degree of definition setter 191, a conveyance speed at which the conveyor 120 conveys the formable sheet 10. As the degree of definition set by the degree of definition setter 191 decreases, the conveyance speed determiner 193 reduces the conveyance speed at which the conveyor 120 conveys the formable sheet 10.

Specifically, in a case in which the degree of definition is relatively high, as illustrated in FIG. 7, the electromagnetic waves are irradiated in a highly dense manner in a narrow range on the formable sheet 10. In this case, the conveyance speed of the formable sheet 10 is set relatively fast such that the electromagnetic waves are irradiated in a concentrated manner for a short amount of time on each region of the formable sheet 10. As a result, each region of the formable sheet 10 distends before heat spreads to the surrounding regions and, as such, high-definition unevennesses 52 are easier to form.

In contrast, in a case in which the degree of definition is relatively low, as illustrated in FIG. 8, the electromagnetic waves are irradiated in a low density manner across a wide range on the formable sheet 10. In this case, the conveyance speed of the formable sheet 10 is set relatively slow such that the electromagnetic waves are irradiated for a longer amount of time on each region of the formable sheet 10. As a result, each region of the formable sheet 10 distends smoothly and, as such, not-high-definition unevennesses 52 are easier to form.

When the conveyance speed determiner 193 determines the conveyance speed, the conveyance speed determiner 193 notifies the conveyor 120 of the determined conveyance speed via the input/output interface 185. When the conveyor 120 receives the notification of the conveyance speed from the conveyance speed determiner 193, the conveyor 120 causes the driving roller 124b to rotate at a rotation speed that corresponds to the conveyance speed in the received notification. As a result, the conveyor 120 conveys the formable sheet 10 at the conveyance speed determined by the conveyance speed determiner 193.

Thus, the shaping device 100 according to Embodiment 2 changes the focus point P of the electromagnetic waves and also changes the conveyance speed of the formable sheet 10 in accordance with the degree of definition of the unevennesses 52 to be formed on the formable sheet 10. As a result, the degree of definition of the unevennesses 52 to be formed on the formable sheet 10 can be adjusted in a finer manner than when only changing the focus point P.

### Modified Examples

Embodiments of the present disclosure are described above, but these embodiments are merely examples and do not limit the scope of application of the present disclosure. That is, various applications of the embodiments of the present disclosure are possible, and all embodiments are included in the scope of the present disclosure.

For example, in the embodiments described above, the focus point adjuster 155 moves the entire irradiator 150, including the lamp 151 and the reflector 152, to adjust the position of the focus point P of the electromagnetic waves irradiated by the irradiator 150. However, a configuration is possible in which the focus point adjuster 155 moves at least one of the lamp 151 or the reflector 152 to adjust the position of the focus point P.

As an example, the focus point adjuster 155 may move the lamp 151 in the Z direction while the position of the reflector 152 is fixed. In this case, since the lamp 151 moves, the position of the lamp 151 deviates from the first focal point of the reflector 152. As such, the focus point P of the electromagnetic waves deviates from the second focal point, and deviates from on the formable sheet 10 being conveyed on the conveyance route R. Alternatively, the focus point adjuster 155 may move the reflector 152 in the Z direction while the position of the lamp 151 is fixed. In this case, since the reflector 152 moves, the two focal points of the reflector 152 move and the position of the lamp 151 deviates from the first focal point of the reflector 152. As such, the focus point P of the electromagnetic waves deviates from the second focal point, and deviates from the front surface of the formable sheet 10 being conveyed on the conveyance route R. Thus, the focus point adjuster 155 moves at least one of the lamp 151 or the reflector 152 to adjust the position of the focus point P.

In the embodiments described above, the focus point adjuster 155 moves the irradiator 150 in the direction away from the formable sheet 10, that is, in the up direction (the +Z direction) to move the focus point P from on the formable sheet 10. However, a configuration is possible in which the focus point adjuster 155 moves the irradiator 150 in the direction approaching the formable sheet 10, that is, in the down direction (the −Z direction) to move the focus point P from on the formable sheet 10. Regardless of whether the irradiator 150 is moved up or down, the electromagnetic waves irradiated on the formable sheet 10 spread on the formable sheet 10 and, as such, it is possible to lower the degree of definition of the unevennesses 52 to be formed on the formable sheet 10.

In the embodiments described above, the degree of definition setter 191 sets one degree of definition for one formable sheet 10. However, a configuration is possible in which the degree of definition setter 191 sets different degrees of definition for each region of one formable sheet 10. Moreover, a configuration is possible in which, as the one formable sheet 10 is being conveyed by the conveyor 120, the focus point adjuster 155 moves the focus point P of the electromagnetic waves in accordance with the degrees of definition set for each region by the degree of definition setter 191.

As an example, a configuration is possible in which the formable sheet 10 is a long sheet (for example, a sheet rolled into a roll shape), and the conveyor 120 conveys the long formable sheet 10 in the longitudinal direction of the long formable sheet 10. Moreover, a configuration is possible in which the formable sheet 10 is divided into a plurality of regions in the longitudinal direction of the formable sheet 10, and the degree of definition setter 191 sets different degrees of definition for each of the plurality of regions the formable sheet 10.

In this case, the focus point adjuster 155 moves at least one of the lamp 151 or the reflector 152 in the Z direction every time the formable sheet 10 is conveyed, by the conveyor 120, the length in the longitudinal direction of each region. As a result, the focus point adjuster 155 moves the focus point P of the electromagnetic waves to a position corresponding to the degree of definition set for each region. Switching the focus point P on the basis of the region to be irradiated with the electromagnetic waves makes it possible to produce, from one formable sheet 10, a shaped object 50 having degrees of definition of the unevennesses 52 that differ by region.

In the embodiments described above, the conveyor 120 conveys the formable sheet 10 along a convexly curved conveyance route R. However, the conveyor 120 may convey the formable sheet 10 along any conveyance route, not only the convexly curved conveyance route R.

As an example, FIG. 13 illustrates a configuration of a shaping device 100a according to a modified example. As illustrated in FIG. 13, the shaping device 100a includes a conveyor 120a that conveys the formable sheet 10 along a flat conveyance route R′, the irradiator 150 that irradiates the electromagnetic waves on the sheet 10 that is being conveyed by the conveyor 120a, and the focus point adjuster 155 that adjusts the position of the focus point P of the electromagnetic waves irradiated by the irradiator 150. Since the conveyance route R′ of the shaping device 100a is flat, the conveyor 120a does not include the guide 122 and the tension roller 124c that cause the conveyor belt 126 to convexly curve. Even in a case, such as this, in which the irradiator 150 irradiates the electromagnetic waves on the formable sheet 10 that is being conveyed along the flat conveyance route R′, the focus point adjuster 155 can adjust, in accordance with the degree of definition of the unevennesses 52, the position of the focus point P of the electromagnetic waves irradiated by the irradiator 150. As a result, it is possible to form, on the formable sheet 10, unevennesses 52 having a degree of definition that corresponds to the preferences of the user.

In the embodiments described above, the formable sheet 10 includes the base 20 and the thermally expansive layer 30. However, the formable sheet 10 described above in the embodiments is merely an example, and a variety of formable sheets 10 with different layer configurations, sizes, thicknesses, and the like can be used. For example, a configuration is possible in which the formable sheet 10 includes an ink receiving layer that absorbs and receives ink. The ink receiving layer is formed from a material suitable for holding printing ink, toner, and the like on the surface of the ink receiving layer. Alternatively, the formable sheet 10 may include a layer made from another desired material.

In the embodiments described above, in the controllers 181 and 181a, the CPU executes the program stored in the ROM, thereby functioning as the degree of definition setter 191, the focus point determiner 192, and the conveyance speed determiner 193. However, in the present disclosure, the controllers 181 and 181a may include, for example, an Application Specific Integrated Circuit (ASIC), a Field-Programmable Gate Array (FPGA), various control circuitry, or other dedicated hardware instead of the CPU, and this dedicated hardware may function as the degree of definition setter 191, the focus point determiner 192, and the conveyance speed determiner 193. In this case, the functions of each of the components may be realized by individual pieces of hardware, or the functions of each of the components may be collectively realized by a single piece of hardware. Additionally, the functions of each of the components may be realized in part by dedicated hardware and in part by software or firmware.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A shaping device, comprising:
a conveyor that conveys a formable sheet that distends due to being irradiated with electromagnetic waves;
an irradiator that irradiates the electromagnetic waves on the formable sheet being conveyed by the conveyor; and
a focus point adjuster that adjusts a position of a focus point of the electromagnetic waves irradiated by the irradiator; wherein
the focus point adjuster adjusts the position of the focus point in accordance with a degree of definition of an unevenness to be caused to form on the formable sheet due to distension of the formable sheet.

2. The shaping device according to claim 1, wherein
the irradiator includes a lamp that emits the electromagnetic waves, and a reflector that reflects, toward the formable sheet being conveyed by the conveyor, the electromagnetic waves emitted from the lamp, and
the focus point adjuster adjusts the position of the focus point by moving at least one of the lamp or the reflector in a direction perpendicular to the formable sheet being conveyed by the conveyor.

3. The shaping device according to claim 1, further comprising:
a degree of definition setter that sets the degree of definition, wherein
the focus point adjuster adjusts the position of the focus point in accordance with the degree of definition set by the degree of definition setter.

4. The shaping device according to claim 3, wherein as the degree of definition set by the degree of definition setter becomes lower, the focus point adjuster moves the position of the focus point farther from on the formable sheet being conveyed by the conveyor.

5. The shaping device according to claim 3, wherein the conveyor changes, in accordance with the degree of definition set by the degree of definition setter, a conveyance speed at which to convey the formable sheet.

6. The shaping device according to claim 5, wherein the conveyor reduces the conveyance speed as the degree of definition set by the degree of definition setter becomes lower.

7. The shaping device according to claim 3, wherein the degree of definition setter sets the degree of definition in accordance with a shaped object to be produced from the formable sheet.

8. The shaping device according to claim 3, wherein
the formable sheet is a long sheet,
the conveyor conveys the formable sheet in a longitudinal direction of the formable sheet, and
the degree of definition setter sets a different degree of definition for each of a plurality of regions of the formable sheet, the plurality of regions being obtained by dividing the formable sheet in the longitudinal direction of the formable sheet.

9. The shaping device according to claim 1, wherein
the formable sheet includes a base,
a thermally expansive layer that is laminated on a first main surface of the base and that expands due to being heated, and
a heat conversion layer that is laminated on at least one of the base or the thermally expansive layer, and that heats the thermally expansive layer by absorbing the electromagnetic waves and converting the electromagnetic waves to heat.

10. A production method for producing a shaped object from a formable sheet that distends due to being irradiated with electromagnetic waves, the production method comprising:
adjusting a position of a focus point of the electromagnetic waves to be irradiated on the formable sheet;
conveying the formable sheet; and
irradiating the formable sheet being conveyed with the electromagnetic waves; wherein
when adjusting the position of the focus point, the position of the focus point is adjusted in accordance with a degree of definition of an unevenness to be caused to form on the formable sheet due to distension of the formable sheet.

11. The production method according to claim 10, wherein
the formable sheet includes
a base,
a thermally expansive layer that is laminated on a first main surface of the base and that expands due to being heated, and
a heat conversion layer that is laminated on at least one of a second main surface of the base or the thermally expansive layer, and that heats the thermally expansive layer by absorbing the electromagnetic waves and converting the electromagnetic waves to heat.
